(19) United States
(12) Patent Application Publication
(10) Pub. No.: US 2016/0250880 A1
(43) Pub. Date: Sep. 1, 2016

(54) METHOD FOR PRODUCING MAILING COVERS AND MACHINE IMPLEMENTING SAID METHOD

(71) Applicant: ACTI MEDIAS S.A.S, Toulouse (FR)

(72) Inventors: Julien BLANC, Limoges (FR); Charles DECK, Muret (FR); Thierry FREBOURG, Aix les Bains (FR); Jean-Claude PRENEL, Sacquenville (FR)

(21) Appl. No.: 15/030,934

(22) PCT Filed: Oct. 20, 2014
(86) PCT No.: PCT/IB2014/002169

§ 371 Date: Apr. 21, 2016

(30) Foreign Application Priority Data
Oct. 21, 2013 (FR) 1360250

(51) Int. Cl. B42D 5/02; B42D 15/00

(52) U.S. Cl. CPC B42D 5/025; B42D 15/008

(57) ABSTRACT

A method for producing mailing covers from either a strip (101) or a sheet (104) of material, each mailing cover (32) comprising printed content documents (3) and a printed envelope document (2). During the method, cutting the content documents (3), stacking them in a bundle and folding them in the format of the mailing cover, cutting and creasing the envelope documents (2), folding side flaps (22) of the envelope document (2) on the folded content documents (3), applying glue on side flaps (22) and/or on back (24) of the envelope document (2), folding the envelope document (2) in two around the folded content documents (3), laterally closing the envelope document (2) by glueing the back (24) on the side flaps (22), and then applying glue on closing flap (21) and folding the closing flap back (24) of envelope document (2) to transversely close and thus complete mailing cover (32).

### TECHNICAL SCOPE

The invention relates to a method for producing mailing covers from a sheet or a strip of material, in particular paper, to obtain closed mailing covers, wherein each mailing cover may comprise either one single printed envelope document whose content can vary from one cover to another, or at least one printed content document associated with a printed envelope document, while the number of content documents can vary from one cover to another.

The invention also relates to a production machine implementing this method.

### PRIOR ART

More or less automated machines for producing mailing covers are widespread in the companies that have to produce large volumes of mail, that is to say several thousands dispatches per day. This is in particular the case of banks, insurance companies, public bodies, mail order companies, mail preparation firms, etc. One commonly talks about “mail preparation”, “transaction mail” or “hybrid mail”. In the case of “mail preparation”, the documents sent are identical for a given advertising campaign and generally customized with the identification of the addressee. For the “transactional mail”, every cover is unique as the documents it contains are personal and confidential for every addressee, such as for example account statements, invoices, insurance policies, etc. In the case of the “hybrid mail”, every cover is unique because its content is generated by the person herself through the Internet network, via a mail publishing and sending company.

A method and a machine are known from publication U.S. Pat. No. 2,983,201 for manufacturing only envelopes in which the side flaps are folded before folding the back, so that they are positioned inside the envelope and that the obtained envelopes correspond to the standard format. However, this machine does not allow the simultaneous production of content documents, Publication U.S. Pat. No. 4,530,731 also discloses a method for producing mailing covers, wherein the content document is attached to the envelope document in a same paper strip. This way, the obtained mailing cover is reduced to only one format, it can contain only one content document and can neither be modified nor customized.

Publication EP 1 693 184 offers a continuous and automated method for the production of mailing covers from one single paper strip on which the documents to be inserted in the envelope and the envelope for closing the mailing cover are printed successively, each envelope and the documents it is to contain are identified by a bar code that allows customizing the mailing covers and therefore avoiding inserting errors. In the described method, the documents and the envelopes are arranged in the paper strip in order to fill the whole strip so as to limit or even suppress waste. The documents are separated from the envelopes by a transversal cut by means of a guillotine, then the sides of the envelope are formed by a die. Several dies may be positioned in series and selected according to the format of the envelope. A control unit allows controlling automatically the production line according to variables such as the number of documents per cover, the format of the envelope, etc. and uses a bar code or similar containing said variables printed on the paper strip. In all cases, the method provides a step for turning either the content of the cover or the envelope by a quarter turn before assembling the content and the envelope to close the cover by folding and gluing in this order the closing flap and then the side flaps over the back of the envelope. This inescapable turning step requires a specific station that raises the cost and increases the length of the production machine. Furthermore, the side flaps of the envelope remain visible on the back of the envelope, which does not comply with the standard format of the envelopes and is therefore not satisfactory.

Publication WO 2009/093186 offers a method and a device for producing mailing covers wherein the envelope documents and the content documents are limited to the A4 format. They are deviated on two paths. Along a first path located in the upper section, the content documents are turned by 90° to be fold in three. Along the second path located in the lower section, the envelope documents are turned over to position the printed areas downwards, then pivoted to crease the flaps in the diagonal of the envelope documents. Then the content document is assembled with the envelope document, the triangular side flaps are folded on the content document prior to applying glue on and folding the triangular front flap. Finally, glue is applied on the triangular rear flap and it is folded to close the mailing cover. Therefore, the mailing cover obtained has a shape and a format that do not comply with the mail standards and are invariable.

Publication WO 2007/012740 also offers a continuous and automated method for the production of mailing covers from a paper strip wherein the documents and the envelopes are cut in the longitudinal direction by a dynamic cutting device able to follow a profile that can be as well curved as rectilinear. So this method has the advantage of allowing the production of customized and unique mailing covers that may be different from each other in terms of format and of content. However, the dynamic cut implies a reduction of the production rates and a loss of cutting quality With this method too, the side flaps of the envelope are folded and glued on the back of the envelope and remain apparent, which is not satisfactory from the esthetic point of view.

### DESCRIPTION OF THE INVENTION

This invention aims to offer a new continuous and automated method for producing customized mailing covers, offering a simple, reliable, compact and cost-effective, modular and very flexible solution that can be adapted to any digital printer and be integrated in any mailing line, allowing both the production of single mailing covers and production at industrial rate, while realizing envelopes at the standard market format, of good quality both in terms of cutting and of glueing, and easily recyclable, that is to say without addition of other material than recyclable materials.

To that purpose, the invention relates to a production method of the kind described in the preamble, wherein one carries out at least the following steps for a mailing cover comprising only an envelope document:
a) one prints the envelope documents arranged along a same orientation on said strip or said sheet of material,
b) one prints simultaneously an identification code on said envelope documents according to the mailing covers to be produced,
c) one prints the content of every mailing cover directly on the back of every envelope document,
d) one cuts and creases the envelope documents in said strip or in said sheet, forming a back and a front delimited by a folding line, a closing flap and two side flaps delimited by folds,
e) one folds the side flaps of the envelope documents,
f) one applies glue on the side flaps and/or on the back of said envelope documents,
g) one folds in two the envelope documents and one closes laterally the envelope documents by glueing the back on said side flaps,
h) one applies glue and one folds the closing flap on the back of the envelope documents to close transversally the envelope documents and therefore complete the mailing covers, and
i) one controls said steps according to the identification codes printed on said envelope documents, which are specific to every mailing cover to be produced.

To that purpose, the invention also relates to a production method of the kind described in the preamble, wherein one carries out at least the following steps for a mailing cover comprising an envelope document associated to one or several content documents.
a) one prints the envelope documents and the content documents arranged along a same orientation on said strip or said sheet of material, said envelope documents and said content documents being printed one next to the other and/or after the other in the order of the mailing covers to be produced, each envelope document being followed or preceded by the corresponding content document(s),
b) one prints simultaneously an identification code on said envelope documents and on said content documents in order to associate them to every mailing cover to be produced,
c) one cuts the content documents from said strip or said sheet,
d) one cuts and creases the envelope documents, forming a back and a front delimited by a folding line, a closing flap and two side flaps delimited by folds,
e) one accumulates and/or one folds the content documents of every mailing cover,
f) one assembles the folded content documents with the corresponding envelope documents,
g) one folds the side flaps of the envelope documents on the folded content documents,
h) one applies glue on the side flaps and/or on the back of the envelope documents,
i) one folds in two the envelope documents around the folded content documents, and one closes laterally the envelope documents by glueing the back on said side flaps,
j) one applies glue on the closing flap and one folds it on the back of the envelope documents to close them transversally and therefore complete the mailing covers, and
k) one controls said steps according to the identification codes specific to every mailing cover to be produced printed on said content documents and on said envelope documents.

One preferably prints the envelope documents and/or the content documents on a strip or a sheet having at least a transversal dimension larger than the total transversal dimension of the printed documents.

To cut out the envelope documents, one may proceed in two steps, that is to say a first cutting step in which one cuts in said strip or in said sheet rectangles having a format larger than a predefined final format of the envelope documents, followed by a second cutting step in which one cuts and creases in said rectangles said envelope documents to their predefined final format.

To cut out the content documents, one may proceed in one cutting step in which one cuts in said strip or in said sheet the content documents to their predefined final format. One may also proceed in two steps, that is to say a first cutting step in which one cuts in said strip or in said sheet rectangles having a format larger than a predefined final format of the content documents, followed by a second cutting step in which one cuts in said rectangles said content documents to their predefined final format.

One may print on a same strip or on a same sheet the envelope documents and the content documents side by side in two parallel rows.

Preferably, after cutting the envelope documents and the content documents, they are placed back in the chronological order of the mailing covers to be produced, inserting on a single path the envelope documents and the corresponding content documents.

To that purpose, the invention also relates to a machine for producing mailing covers as defined in the preamble, characterized in that it comprises longitudinal and transversal cutting and creasing devices arranged to cut the envelope documents in said strip or in said sheets, forming a back and a front materialized and delimited by a folding line, a closing flap and two side flaps delimited by folds, a device for folding the side flaps of the envelope documents, a device for applying glue on the side flaps and/or on the back of the envelope documents, a folding device arranged for folding the envelope documents in two and closing laterally the envelope documents by glueing the back on said flaps, a device for applying glue on the closing flap and a device for folding the closing flap on the back for closing transversally the envelope documents forming said mailing covers, optical means arranged for reading identification codes printed at least on the envelope documents associated with every mailing cover to be produced, and a central control unit arranged to control said devices according to said identification codes.

In the case where every mailing cover is made of at least one printed content document and of one printed envelope document, and where the number of content documents may vary from one mailing cover to another, the machine comprises advantageously longitudinal and transversal cutting means arranged for cutting said content documents in the strip or in the sheets, and a device for assembling said content documents with said corresponding envelope documents.

The machine may comprise at choice a device for printing the envelope documents and/or the content documents arranged remotely from the other devices to form a discontinuous production machine, or in line with the other devices to form a continuous production machine.

In a preferred embodiment, the machine comprises at least one first cutting device arranged for cutting in said strip or in said sheets rectangles having a format larger than a predefined final format of the envelope documents, and at least one second cutting device arranged for cutting and creasing in said rectangles said envelope documents to their predefined final format.

In this case, it also comprises advantageously at least one cutting device arranged for cutting said content documents to their predefined final format.

It may also comprise at least one first cutting device arranged for cutting in said strip or in said sheet rectangles having a format larger than a predefined final format of the content documents, and a second cutting device arranged for cutting in said rectangles said content documents to their predefined final format.

In the preferred embodiment, the assembling device comprises two routing circuits arranged for separating the envelope documents from the content documents, and comprises at least one device for folding the content documents previously stacked in a bundle.

### BRIEF DESCRIPTION OF THE DRAWINGS

The present invention and its advantages will be better revealed in the following description of two embodiments given as non limiting examples, in reference to the drawings in appendix, in which:

FIGS. 1 to 3 represent schematically, in three sections, a first embodiment of the production machine according to the invention, and

FIG. 4 represents schematically a second embodiment of the production machine according to the invention,

### ILLUSTRATIONS OF THE INVENTION AND WAYS OF REALIZING IT

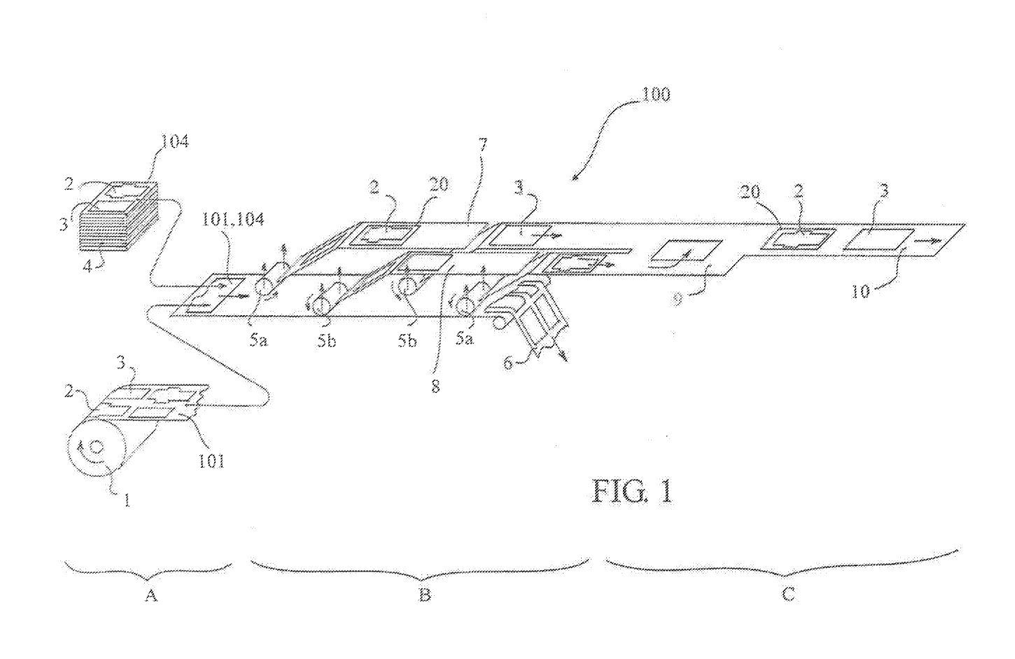

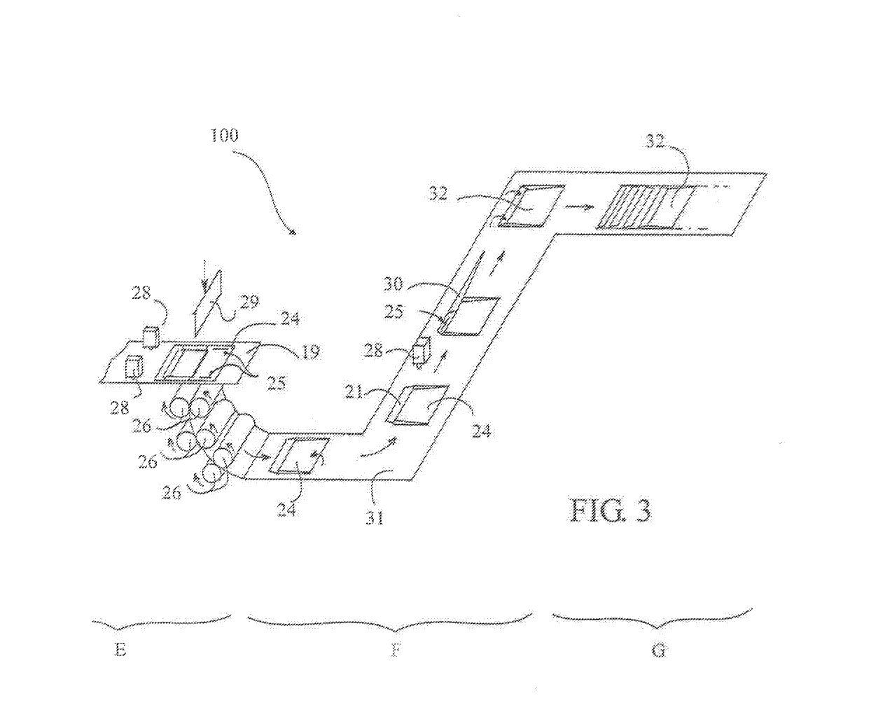

Referring to FIGS. 1 to 3, the machine 100 for producing mailing covers 32 (FIG. 3) according to the invention is designed for implementing a new production method wherein the following steps are carried out preferably in chronological order.

Referring to FIG. 1, production machine 100 is fed with a strip of material 101 or a sheet of material 104 that may be paper or any similar material, and that can come indifferently in a roll 1 or in a pack 4 of sheets. The width of strip 101 or of sheet 104 of material is larger than the final dimension of the documents 2, 3, already printed or to be printed. In the illustrated example, strip 101 and sheets 104 are already printed. Printing may be separated and carried out on another site, or integrated in the production process of mailing covers 32.

In all cases, one prints the document forming envelope 2 and the document(s) forming content 3 of the envelope in the order of the mailing covers 32 to be produced, for example starting with envelope document 2, followed, side by side, and one after the other, by content documents 3. This order may of course be reversed. In the illustrated example, strip 101 or sheet 104 of material is adapted for two document widths and allows printing side by side two documents 2, 3, on two parallel rows, oriented so that their length is aligned with the length of the strip and in the running direction of the material in production machine 100. Of course, other embodiments are possible, providing a strip or a sheet of material adapted for one single document width or for more than two document widths. Likewise, the documents may be oriented differently. However, the represented example is a good compromise in terms of production rate, size and investment costs for production machine 100, as no turning modules are to be planned.

During printing, one prints an identification code or similar on envelope documents 2 and on content documents 3, allowing to identify content document(s) 3 associated to every envelope document 2 in order to ensure the integrity of the mailing covers 32 produced. These identification codes are read by optical readers or by any other equivalent optical means and are used for controlling the various stations of production machine 100.

The envelope documents 2 and the content documents 3 are cut by means of magnetic cutting cylinders 5a, 5b or similar, or guillotines or similar, or rotary cutting devices, or water jet or laser cutting devices. In the illustrated example, documents 2, 3 follow two parallel paths during which they are cut and deviated for example by a suction system (not represented) on two parallel transfer tables 7, 8 located in the same plane. Documents 2, 3 are then directed by 4a first switching zone 9 towards a single transfer table 10, where they are brought back on one single path and positioned one after the other in the order of the mailing cover 32 to be produced, for example starting with envelope document 2 followed by content documents 3. The order of mailing cover 32 may be reversed. On the one hand, the cutting operation allows creating envelope documents 2 by means of cylinders 5a that cut in strip 101 or in sheet 104 rectangles 20 having a predetermined format, in which envelope documents 2 are inscribed. On the other hand, it allows creating content documents 3 by means of cutting cylinders 5b that cut in strip 101 or in sheet 104 rectangles having a predetermined format that correspond to said content documents 3, for example in the A4 format. The remaining skeleton 6 of strip 101 or sheet 104 of material is evacuated and can be recycled.

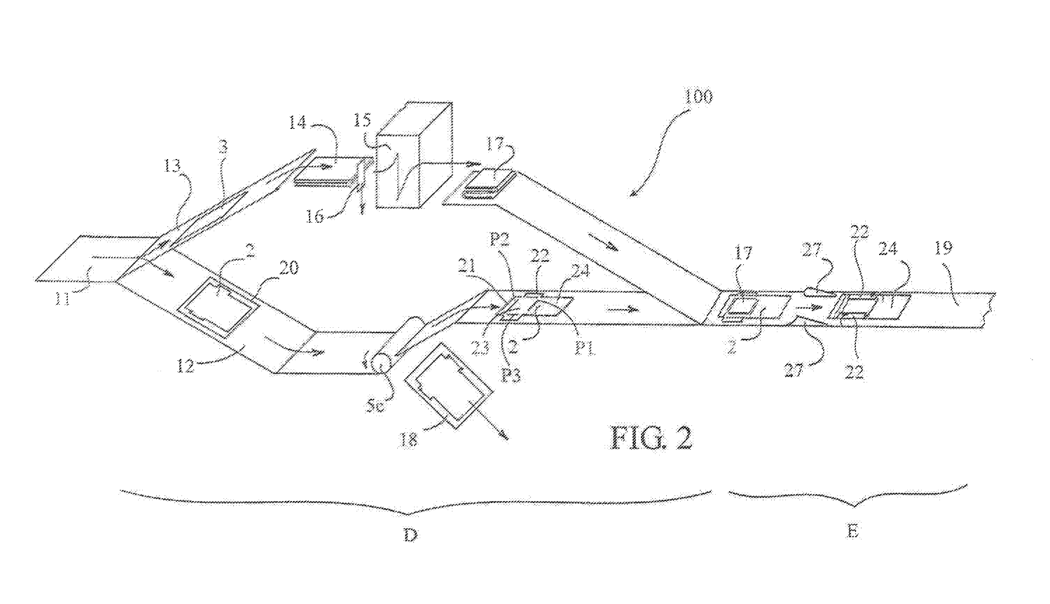

Referring to FIG. 2, cut documents 20 and 3 are then separated by a second switching zone 11 in two parallel routing circuits 12, 13 located in two superimposed planes according to the reading of the identification code. In the represented example, rectangles 20 of envelope documents 2 are deviated towards lower routing circuit 12 and content documents 3 are deviated towards upper routing circuit 13. In the lower routing circuit 12, a cutting cylinder 5c or similar cuts envelope documents 2 from rectangles 20, creating closing flap 21 and side flaps 22 that delimit the front 23 and the back 24 of envelope 2 and one creases simultaneously or not folds P2, P3 that separate flaps 21, 22 from front 23 and folding line P1 that separates front 23 from back 24. Cutting and creasing are advantageously carried out simultaneously by cutting cylinder 5c that comprises for that purpose sections in relief with a different depth. The skeleton 18 of rectangles 20 that remains after cutting is evacuated. In upper routing circuit 13, content documents 3 are superimposed to form a bundle 14 that corresponds to envelope document 2 that is currently being cut and creased in lower routing circuit 12. The content documents 3 of bundle 14 are aligned and checked by a controlled stop 16 that may be mechanical, electrical, optical or similar, before they are routed in a folding device 15 that folds bundle 14 of content documents 3 for example to form a folded bundle 17 in order to put content documents 3 to the format of envelope document 2. In upper routing circuit 13, it is also possible to insert enclosures (not represented) above folded bundle 17 intended to be placed in the cover.

One then brings together on a same assembly table 19 folded bundle 17 of content documents 3 and envelope document 2, placing folded bundle 17 on front 23, then one folds side flaps 22 of envelope document 2 above folded bundle 17 by means of side deflectors 27 or of any technically equivalent means.

Referring now to FIG. 3, one applies glue 25 on back 24 of envelope document 2 by means of glue application nozzles 28, one then folds envelope document 2 around folded bundle 17 of content documents 3, glueing simultaneously back 24 on side flaps 22 to close envelope 2 laterally. It is also possible to apply glue 25 on side flaps 22 instead of back 24 or on side flaps 22 and on back 24. The folding operation is performed by a folding device 29 or by any equivalent technical means, which moves down vertically, perpendicularly to assembly table 19, and which takes envelope document 2 and folded bundle 17 of content documents 3 towards at least one pair of counter-rotating pressure rollers 26 that press folded envelope 2 around its content, close it laterally by glueing side flaps 22 and back 24, then forward partly closed envelope 2 towards a finishing table 31.

On finishing table 31, one applies glue 25 on closing flap 21 by means of another glue application nozzle 28, then one folds closing flap 21 on back 24 by means of a deflector 30 to close envelope 2 and complete a mailing cover 32. Finally, one stacks the obtained mailing covers 32, ready for stamping and dispatch, in an offset stack or according to any other presentation or to any other storage mode. All steps of this production method are controlled according to the number of content documents 3 per envelope document 2 for each mailing cover 32 to be produced and that is determined by the identification code or similar, printed simultaneously with said documents 2, 3.

Every mailing cover 32 can either comprise only envelope document 2 or one or several content document(s) 3 printed in the form of a sheet in A4 format for example, and/or an envelope document 2 in the 110×220 format for example. The cutting modules will of course be adapted to the formats to be produced.

To that purpose, production machine 100 comprises at least the following work zones:
a printing zone A where the envelope documents 2 and the content documents 3 are printed on a continuously running strip of material 101 or sheet of material 104 in an order predefined by the numerical data entered in printing unit A and leading to the simultaneous printing of identification codes (not represented) such as bar codes or similar, on each of documents 2, 3,
a cutting zone B where the content documents 3 on the one hand and the rectangles 20 from which envelope documents 2 will be cut later on the other hand are cut to the predetermined format in length and width,
a switching zone C where envelope documents 2 and content documents 3 are placed back in the chronological order of the mailing covers 32 to be produced,
an assembly zone D where one or several content documents 3 are assembled with a corresponding envelope document 2 after having previously cut envelope document 2 to the definitive format of envelope 2 and after having previously folded the content document(s) 3 placed in a bundle 14,
a zone F where mailing cover is confectioned, where one folds side flaps 22 of envelope document 2, one applies glue on back 24 of envelope document 2, then one folds envelope document 2 in two around content documents 3 by folding the back of envelope 2 on the front to glue side flaps 22 and close envelope 2 laterally.
a closing zone F where glue is applied on closing flap 21, which is folded on back 24 of envelope document 2 to close envelope 2 longitudinally,
a storage zone G where the closed mailing covers 32 are stored, checked and/or stamped before they are dispatched, and
a central control unit (not represented) arranged to control said zones according to the mailing covers 32 to be manufactured.

Printing zone A comprises in particular a printing device (not represented) fed either by a roll of material such as blank paper carried by an unwinding device (not represented) and supplying a printed strip 101 to cutting zone B, or by a pack of sheets stored in a magazine (not represented) and supplying printed sheets 104. This printing device is of a known type based for example on a digital laser or inkjet printing technique, an offset printing technique or similar, in black or in colors. This printing device may be integrated in or dissociated from the rest of production machine 100, as in the illustrated example. If it is dissociated, the printed paper strip 101 is repackaged in a roll 1 by a rewinder, or the printed sheets 104 are repackaged in packs 4 for feeding cutting zone B.

Cutting zone B comprises a plurality of cutting devices 5a, 5b arranged to cut longitudinally and transversally strip 101 or sheet 104 of material in order to form on the one hand rectangles 20 in which envelope documents 2 are inscribed and, on the other hand, rectangles corresponding to content documents 3. The cutting devices may be cutting cylinders 5a, 5b, as illustrated, or guillotines or scissors placed longitudinally and transversally, or rotary cutting devices, or cutting devices using a high-pressure liquid jet or a laser beam. Cutting cylinders 5a, 5b may be of the magnetic type, where the plate of the cutting die is fastened to the carrier cylinder by magnetization, or of the mechanical type, where the die plate is fastened to the carrier cylinder by mechanical fastening elements. Cutting zone B extends on at least two levels and comprises at least two parallel transfer tables 7, 8 arranged in the same plane. It also comprises a suction device (not represented) that allows directing the cut documents towards one or the other transfer table 7, 8 in order to place them back in the chronological order of the mailing covers 32 to be produced. It finally includes a waste evacuation device (not represented) to evacuate skeleton 6 remaining of strip 101 or sheets 104 after cutting. At this point, envelope documents 2 are not cut to the format in order not to complicate their handling, which would require more complex and more expensive gripping and guiding means than those required for handling, material rectangles 20.

Switching zone C comprises a deflecting device (not represented), for example in the form of a slanted conveyor belt that allows transferring the cut documents coming from transfer table 8 towards single transfer table 9, inserting them between the cut documents coming from transfer table 7 in the chronological order of the mailing covers 32 to be produced.

Assembly zone D comprises two dissociated and superimposed routing circuits 12, 13 fed by a sorting shutter arranged for separating content documents 3 from envelope documents 2 and direct each of them towards a routing circuit 12, 13. The content documents 3 intended for a mailing cover 32 are superimposed in a bundle 14 for example in upper routing circuit 13, while the corresponding envelope document 2 is cut to the format of envelope 2 by a cutting device 5c in lower routing circuit 12. The upper routing circuit 13 comprises a mechanical, electrical, optical or similar controlled stop 16 that allows the accumulation of content documents 3 to form a bundle 14 and a device 15 for folding content document 3 or bundle 14 of superimposed content documents 3 to put them to the format of envelope 2. As for cutting zone B, cutting device 5c may be embodied by various means and for example by a cutting cylinder of the magnetic or mechanical type. The lower routing circuit 12 is connected to the suction device of cutting zone B for evacuating the skeletons 18 that remain from rectangles 20 after cutting envelope documents 2. The two routing circuits 12, 13 meet in zone E where the mailing cover is confectioned, where the folded bundle 17 of content documents 3 is placed on the open envelope document 2. At this point, or just before this point, it is possible to add additional feeding means (not represented) in which additional content documents are stored, which are to be inserted in the future mailing cover 32, such as advertising documents or others.

Zone E where the mailing cover is confectioned comprises a first folding device provided with lateral deflectors 27 for folding side flaps 22 of envelope document 2 on folded bundle 17 of content documents 3 during their movement on assembly table 19. It comprises glue application nozzles 28 arranged to apply glue 25, for example a hot-melt glue, a cold glue, or any other suitable glue. It is applied on back 24 of envelope document 2 in front of side flaps 22 during the movement of the documents on assembly table 19. It could also be applied on side flaps 22 of envelope document 2 in addition to or in place of back 24. Zone F where the mailing cover is confectioned then comprises a second folding device 29 or any other equivalent means that is moved towards and through assembly table 19. Folding device 29 is arranged for taking with it documents 2, 3 towards counter-rotating pressing rollers 26 that will fold envelope document 2 around folded bundle 17 of content documents 3 and glue back 24 on side flaps 22 of envelope document 2.

Closing zone F comprises a glue application nozzle 28 arranged on the path of finishing table 31 for applying glue 25 on closing flap 21 or envelope document 2. It is followed by a deflector 30 for folding closing flap 21 on back of envelope 2 and closing mailing cover 32. Mailing cover 32 is routed by finishing table 31 towards storage zone G where it is stored before it is dispatched or directly routed towards a dispatching zone (not represented). A device (not represented) for franking mailing covers 32 combined with a weighing device may be integrated in storage zone G. Likewise, an additional control device (not represented) may complete this production machine 100 for checking the completeness of the produced batches of mailing covers 32 with respect to the ordered batches.

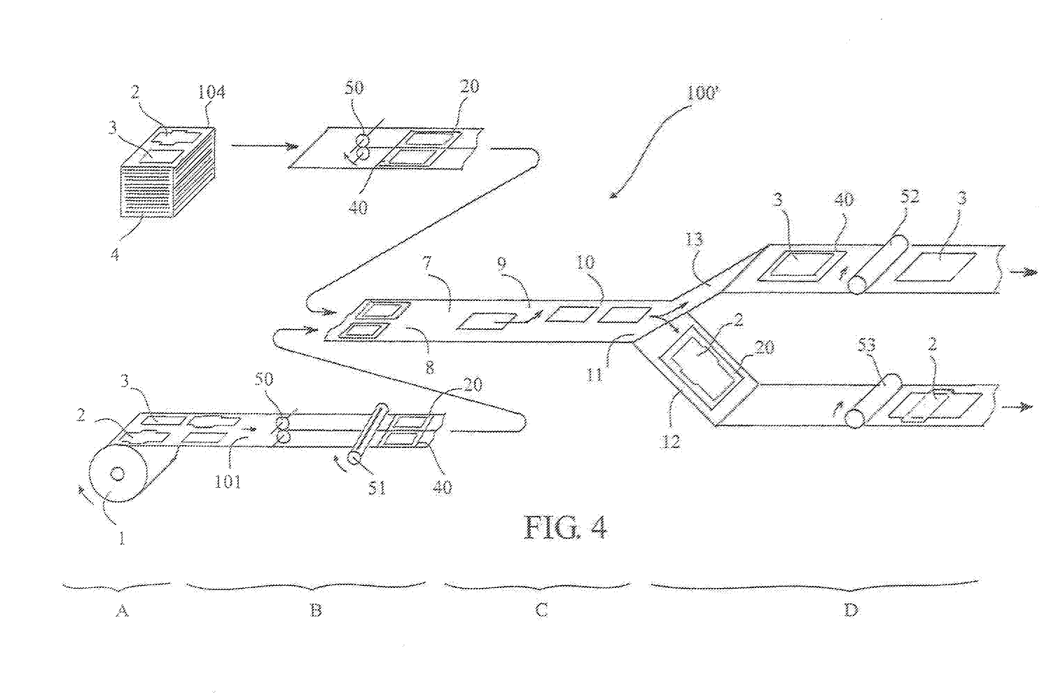

FIG. 4 only illustrates zones A to D of a machine 100′ for producing mailing covers 32 according to an embodiment variant of the invention, wherein the cutting of envelope documents 2 and content documents 3 is performed differently. The parts identical to production machine 100 of FIGS. 1 to 3 have the same reference numbers. The production method described above is therefore modified as follows.

In cutting zone B, a first cutting step is performed to form in strip of material 101 or sheets of material 104 rectangles 20, 40 having a format larger than the predefined final format of envelope documents 2 and of content documents 3. If machine 100′ is fed by sheets of material 104 represented on top left of FIG. 4, one cuts the sheets only in the longitudinal direction using a rotary cutter 50 or similar. If machine 100′ is fed by a strip of material 101 represented on bottom left of FIG. 4, one cuts the strip in the longitudinal direction using a rotary cutter 50 or similar, then in the transversal direction using a cutting cylinder 51. This technique allows using simple and inexpensive cutting devices for separating documents 2, 3 printed side by side and one after the other, and to handle rectangular documents that are easy to forward and to index. Of course, if strip of material 101 and sheets of material 104 are dimensioned for one single width of documents 2, 3, the longitudinal cut is not necessary. Likewise, if strip of material 101 and sheets of material 104 are dimensioned for more than two widths of documents 2, 3, additional rotary cutters 50 must be provided.

In assembly area D, when rectangles 20 of envelope documents 2 and rectangles 40 of content documents 3 are directed towards the two superimposed routing circuits 12, 13, one performs a second cutting step to give them their predefined final format. In upper routing circuit 13, rectangles 40 are cut by a cutting cylinder 52 or similar for forming content documents 3 at the predefined final format before they are accumulated in a bundle and folded. In lower routing circuit 12, rectangles 20 are cut by a cutting and creasing cylinder 53 or similar for forming envelope documents 2 at the predefined final format provided with flaps 21, 22 and folds P1, P2, P3.

Depending on the needs, the mailing covers 32 to be produced may comprise only an envelope document 2, in particular if the content of mailing cover 32 is printed directly on the back of said envelope document 2. In this case, the described production machines 100, 100′ can be used without any modification. Only the part relating to the processing of content documents 3 is put out of operation, and more precisely upper routing circuit 13.

### POSSIBILITIES FOR INDUSTRIAL APPLICATION

These working zones A to G are preferably made of independent modules that facilitate their manufacture and assembly according to a configuration adapted to every user, which ensures the whole production machine 100, 100′ great adaptation flexibility. Likewise, these modules can be assembled one following the other to form a continuous production line as illustrated by FIGS. 1 to 3, linear or not, and/or certain modules can be separated from the others, thus forming a discontinuous line.

The control of production machine 100, 100′ is taken in charge by a central control unit (not represented) using a computer program that corresponds to the digital data linked with every mailing cover 32 to be produced, completed by optical means arranged to read the identification codes printed on envelope documents 2 and on content documents 3, these identification codes can be of the OMR, OCR, bar code, etc., type. This computer program therefore allows creating any type of customized and unique mailing covers 32, the number of content documents 3 for every mailing cover 32 belonging to the variable and programmable data, which allows great creation flexibility.

The present invention is not restricted to the examples of embodiment described, but extends to any modification and variant which is obvious to a person skilled in the art while remaining within the scope of the protection defined in the attached claims.

1-16. (canceled)

17. A method for producing mailing covers (32) from either a strip (101) or from a sheet (104) of material, each mailing cover (32) comprising a printed envelope document (2) whose content can vary from one mailing cover to another, the method comprising:
a) printing the envelope documents (2) arranged along a same orientation on the strip (101) or the sheet (104) of material,
b) printing simultaneously an identification code on the envelope documents (2) according to the mailing covers (32) to be produced,
c) printing the content of every mailing cover (32) directly on a back of every envelope document (2),
d) cutting and creasing the envelope documents (2) in the strip (101) or in the sheet (104), forming a back (24) and a front (23) delimited by a folding line (P1), a closing flap (21) and two side flaps (22) delimited by folds (P2, P3),
e) folding side flaps (22) of envelope documents (2),
f) applying glue on side flaps (22) and/or on back (24) of the envelope documents (2),
g) folding in two envelope documents (2) and closing laterally envelope documents (2) by glueing back (24) on the side flaps (22),
h) applying glue on closing flap (21) and folding it on back (24) of envelope documents (2) to close transversally envelope documents (2) and therefore complete mailing covers (32), and
I) controlling the steps according to the identification codes printed on the envelope documents (2), which are specific to every mailing cover (32) to be produced.

18. A method for producing mailing covers (32) from either a strip (101) or a sheet (104) of material, each mailing cover (32) comprising at least one printed content document (3) and a printed envelope document (2) while a number of content documents (3) can vary from one mailing cover to another, the method comprising:
a) printing the envelope documents (2) and the content documents (3) arranged along a same orientation on the strip (101) or the sheet (104) of material, the envelope documents (2) and the content documents (3) being printed one next to the other and/or after the other in the order of the mailing covers (32) to be produced, each envelope document (2) being followed or preceded by the corresponding content document(s) (3),
b) simultaneously printing an identification code on the envelope documents (2) and on the content documents (3) in order to associate them to every mailing cover (32) to be produced,
c) cutting the content documents (3) from the strip (101) or from the sheet (104),
d) cutting and creasing the envelope documents (2), forming a back (24) and a front (23) delimited by a folding line (P1), a closing flap (21) and two side flaps (22) delimited by folds (P2, P3),
e) accumulating and/or folding the content documents (3) of every mailing cover (32),
f) assembling the folded content documents (3) with the corresponding envelope documents (2),
g) folding side flaps (22) of envelope documents (2) on the folded content documents (3),
h) applying glue on side flaps (22) and/or on back (24) of envelope documents (2),
I) folding in two envelope documents (2) around the folded content documents (3), and closing laterally envelope documents (2) by glueing the back (24) on the side flaps (22),
j) applying glue on the closing flap (21) and folding the closing flap (21) on the back (24) of the envelope documents (2) to close them transversely and therefore complete the mailing covers (32), and
k) controlling the steps according to the identification codes specific to every mailing cover (32) to be produced printed on the content documents (3) and on the envelope documents (2).

19. The method according to claim 17, further comprising printing the envelope documents (2) and/or the content documents (3) on a strip (101) or a sheet (104) having at least a transverse dimension larger than the total transverse dimension of the printed documents (2, 3).

20. The method according to claim 19, wherein the cutting of the envelope documents (2) proceeds as two steps, that is to say a first cutting step in which one cuts in the strip (101) or in the sheet (104) rectangles (20) having a format larger than a predefined final format of envelope documents (2), followed by a second cutting step in which one cuts and creases in the rectangles (20) the envelope documents (2) to their predefined final format.

21. The method according to claim 19, wherein cutting of the content documents (3) proceeds as one cutting step in which one cuts in the strip (101) or in the sheet (104) the content documents (3) to their predefined final format.

22. The method according to claim 19, wherein the cutting of the content documents (3) proceeds as two steps, that is to say a first cutting step in which one cuts in the strip (101) or in the sheet (104) rectangles (40) having a format larger than a predefined final format of content documents (3), followed by a second cutting step in which one cuts in the rectangles (40) the content documents (3) to their predefined final format.

23. The method according to claim 18, wherein printing on the same strip (101) or on the same sheet (104) envelope documents (2) and content documents (3) occurs side by side in two parallel rows.

24. The method according to claim 23, wherein, after cutting the envelope documents (2) and the content documents (3), placing the envelope documents (2) and the content documents (3) back in chronological order of the mailing covers (32) to be produced, inserting on a single path the envelope documents (2) and the corresponding content documents (3).

25. A machine (100) for producing mailing covers (32) from either a strip (101) or a sheet (104) of material, each mailing cover (32) comprising at least one printed envelope document (2) whose content can vary from one mailing cover to another, the machine implementing the production process according to claim 18,
wherein the machine comprises longitudinal and transversal cutting and creasing devices (5a, 5b, 5c) arranged to cut the envelope documents (2) in the strip (101) or in the sheets (104), forming a back (24) and a front (23) delimited by a folding line (P1), a closing flap (21) and two side flaps (22) delimited by folds (P2, P3), a device (27) for folding side flaps (22) of envelope documents (2), a device (28) for applying glue on side flaps (22) and/or on back (24) of envelope documents (2), a folding device (29, 26) arranged for folding envelope documents (2) in two and closing laterally envelope documents (2) by glueing back (24) on the flaps (22), a device (28) for applying glue on closing flap (21) and a device (30) for folding closing flap (21) on back (24) for closing transverse envelope documents (2) forming the mailing covers (32), optical means arranged for reading identification codes printed at least on envelope documents (2) associated with every mailing cover (32) to be produced, and a central control unit arranged to control the devices according to the identification codes.

26. A production machine (100) for producing mailing covers (32) according to claim 25, every mailing cover (32) is made of at least one printed content document (3) and one printed envelope document (2), where the number of content documents (3) may vary from one mailing cover to another, the machine comprises longitudinal and transversal cutting means (5a, 5b, 5c) arranged for cutting the content documents (3) from the strip (101) or from the sheets (104), and a device for assembling content documents (3) with the corresponding envelope documents (2).

27. The production machine according to claim 25, wherein the production machine comprises a device for printing envelope documents (2) and/or content documents (3) arranged remotely from other devices to form a discontinuous production machine.

28. The production machine according to claim 25, wherein the production machine comprises a device for printing envelope documents (2) and/or content documents (3) arranged in line with the other devices to form a continuous production machine.

29. The production machine according to claim 25, wherein the production machine comprises at least one first cutting device (5a, 5b) arranged for cutting from the strip (101) or from the sheets (104) rectangles (20) having a format larger than a predefined final format of envelope documents (2), and at least one second cutting device arranged for cutting and creasing in the rectangles (20) the envelope documents (2) to their predefined final format.

30. The production machine according to claim 25, wherein the production machine comprises at least one cutting device arranged for cutting the content documents (3) to their predefined final format.

31. The production machine according to claim 25, wherein the production machine comprises at least one first cutting device arranged for cutting from the strip (101) or from the sheet (104) rectangles (40) having a format larger than a predefined final format of content documents (3), and one second cutting device arranged for cutting in the rectangles (40) the content documents (3) to their predefined final format.

32. The production machine according to claim 26, wherein an assembling device comprises two routing circuits (12, 13) arranged for separating the envelope documents (2) from the content documents (3), and comprises at least one device (15) for folding the content documents (3) previously stacked in a bundle (14).
